(19) United States
(12) Patent Application Publication
(10) Pub. No.: US 2025/0033885 A1
(43) Pub. Date: Jan. 30, 2025

(54) METHOD FOR TRANSPORTING A PRODUCT ITEM TO AN ACCESS STATION

(71) Applicant: Autostore Technology AS, Nedre Vats (NO)

(72) Inventor: Kjetil Gilje, Sandeid (NO)

(73) Assignee: Autostore Technology AS, Nedre Vats (NO)

(21) Appl. No.: 18/713,041

(22) PCT Filed: Nov. 21, 2022
(86) PCT No.: PCT/EP2022/082589

§ 371 Date: May 23, 2024

(30) Foreign Application Priority Data
Nov. 30, 2021 (NO) 20211445

(51) Int. Cl. B65G 1/137

(52) U.S. Cl. CPC B65G 1/1378; B65G 2207/26

(57) ABSTRACT

A method transports a product item stored within a first storage container within an automated storage and retrieval system to an access station. The method includes moving the first storage container from a storage column to a transfer station; transferring the product item from the first storage container to a second storage container at the transfer station; and returning the first storage container from the transfer station to the automated storage and retrieval system. The method further includes moving the second storage container from the transfer station to an access station at which a person may access the product item; and returning the second storage container from the access station to the transfer station.

### FIELD OF THE INVENTION

The present invention relates to a method for transporting a product item stored within a first storage container within an automated storage and retrieval system to an access station. The present invention also relates to an automated storage and retrieval system comprising a framework structure and a storage volume comprising storage columns.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c, 301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110, 111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X-and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions. In the framework structure 100, a majority of the columns 105 are storage columns 105, i.e. columns 105 where storage containers 106 are stored in stacks 107.

However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119, 120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119, 120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

WO 2017211596 describes a public access station with a drawer, wherein a person may access a product item from a storage container when the drawer is open.

NO 344750 describes an unloading system, wherein prepicked products stored in cardboard boxes are pushed out through side openings in the storage containers to a conveyor. The conveyor is moving the cardboard box to a target destination, the target destination being a postal service, a delivery service or a pickup point.

WO 2012148287 describes a system wherein objects are transferred to and from an unmanned installation area. The purpose is to avoid personal injuries by preventing persons from going into the unmanned installation area. Objects are transferred both ways.

One object of the present invention is to improve the robustness of an automated storage and retrieval system.

### SUMMARY OF THE INVENTION

The present invention relates to a method for transporting a product item stored within a first storage container within an automated storage and retrieval system to an access station, wherein the method comprises the steps of:
moving the first storage container from a storage column to a transfer station;
transferring the product item from the first storage container to a second storage container at the transfer station;
returning the first storage container from the transfer station to the automated storage and retrieval system;
moving the second storage container from the transfer station to an access station at which a person may access the product item;
returning the second storage container from the access station to the transfer station.

In one aspect, the steps of moving and returning the first storage container comprises moving and returning the first storage container on a first side of a barrier; wherein the steps of moving and returning the second storage container comprises moving and returning the second storage container on a second side of the barrier; wherein the step of transferring the product item comprises transferring the product item from the first storage container to the second storage container through the barrier at the transfer station.

In one aspect, the access station is a public access station at which a public person may retrieve product items. Such a public access station may be referred to as a public pickup point.

In one aspect, the product item is stored within a first storage container stacked in a stack in a storage column within a framework of the automated storage and retrieval system.

In one aspect, the step of transferring the product item from the first storage container to the second storage container at the transfer station comprises transferring all product items from the first storage container to the second storage container. Here, the step of returning the first storage container comprises returning the empty storage container. Alternatively, only one of several product items is transferred from the first storage container to the second storage container at the transfer station.

The first side of the barrier may be referred to as a protected area. The second side of the barrier may be referred to as a non-protected area. The non-protected area may further be separated into a publicly accessible area and an intermediate area by means of structure. The intermediate area is hence forming a buffer area between the protected area and the publicly accessible area.

In one aspect, the step of transferring the product item from the first storage container to a second storage container at the transfer station comprises:
keeping the first storage container at a distance from the second storage container during the transfer.

According to the above, the first storage container is always on the first side of the barrier and never on the second side of the barrier, while the second storage container is always on the second side of the barrier and never on the first side of the barrier. Consequently, the first storage containers are never exposed to the public at the access station. Similarly, the second storage containers, which are exposed to the public at the access station, is never moved into one of the storage columns of the framework structure of the automated storage and retrieval system.

According to the above, the transfer of the product item from the second storage container to the first storage container at the transfer station helps to prevent undesired matter to transfer from the second storage container to the first storage container.

The term “undesired matter” is here referring to matter such as germs which is harmful for people, and matter such as explosives/chemicals etc. which are harmful for people and/or the automated storage and retrieval system on the first side of the barrier.

In one aspect, the step of moving the second storage container comprises:
temporarily storing the second storage container with its product item in a first temporary storage system.

The first temporary storage system is located on the second side of the barrier.

In one aspect, the step of returning the second storage container from the access station to the transfer station comprises:
temporarily storing the second storage container in a second temporary storage system.

Also the second temporary storage system is located on the second side of the barrier.

In one aspect, the step of returning the second storage container from the access station to the transfer station comprises:
bringing the second storage container to a cleaning station for cleaning of the second storage container.

In one aspect, the step of returning the second storage container from the access station to the transfer station comprises:
bringing the second storage container to a disinfection station for disinfection of the second storage container.

The term “disinfection” is used herein to describe a process of neutralizing germs. The term “cleaning” is used herein to describe a process of removing dust/particles/dirt and other undesired matter. Hence, “disinfection” is different from “cleaning”.

In one aspect, cleaning is performed by applying water and a detergent to the second storage container, subsequently the detergent is washed away and finally the second storage container is dried.

In one aspect, the cleaning is performed by a blower or a vacuum cleaner.

In one aspect, the disinfection is performed by applying a disinfection fluid to the second storage container and/or by applying ultraviolet radiation to the second storage container.

In one aspect, the step of returning the second storage container from the access station to the transfer station comprises:
bringing the second storage container to an inspection station for inspection of the second storage container.

In one aspect, the inspection station is designated to look for the above “undesired matter”. In one aspect, the inspection station may comprise a chemical detector for detecting traces of chemical agents in the air adjacent to the second storage container present in the inspection station. Such a chemical detector may detect explosives and other harmful chemical agents. In one aspect, the inspection station may comprise a germ detector for detecting germs present on the second storage container present in the inspection station.

In one aspect, the inspection station comprises a weight sensor for weighing the second storage container.

In one aspect, the inspection station comprises a camera for capturing an image of the second storage container. The weight and/or camera may be used to detect dust/particles/dirt and/or other undesired matter. The camera may utilize visible light, ultraviolet radiation and/or infrared radiation. An ultraviolet radiation sensitive camera may be used to detect germs.

In one aspect, the inspection station is an automatic or manual inspection station. In one aspect, the second storage container is transferred to the cleaning station, the disinfection station and/or the second temporary storage system based on the inspection performed at the inspection station.

In one aspect, the method comprises a step of moving the second storage container to a quarantined location.

In one aspect, the step of transferring the product item from the first storage container to the second storage container at the transfer station comprises:
pivoting the first storage container above the second storage container, thereby causing the product item to tip into the second storage container.

One advantage with this embodiment is that the presently used open-top type of storage containers may be used.

In one aspect, the step of transferring the product item from the first storage container to the second storage container at the transfer station comprises:
pushing the product item sideways out through the first storage container via a first side opening provided in a side wall of the first storage container and further into the second storage container via a second side opening provided in a side wall of the second storage container.

The present invention also relates to a automated storage and retrieval system comprising a framework structure and a storage volume comprising storage columns, wherein a product item is stored within a first storage container stackable in stacks within the storage columns; wherein the automated storage and retrieval system comprises:
an access station at which a person may access the product item;
a transfer station;
   wherein the transfer station comprises:
a first section for receiving the first storage container;
a second section for receiving a second storage container;
an actuator for transferring the product item from the first storage container located in the first section to a second storage container located at the second section;
   wherein the automated storage and retrieval system comprises a first container handler for moving the first storage container between the storage column and the first section of the transfer station;
   wherein the automated storage and retrieval system comprises a second container handler for moving the second storage container between the second section of the transfer station and the access station.

In one aspect, the automated storage and retrieval system comprises a barrier separating the system between a protected area and a non-protected area, wherein the first section of the transfer station is provided within the protected area and wherein the second section of the transfer station is provided within the non-protected area.

In one aspect, the barrier is a physical barrier with a barrier opening allowing transfer of the product item from the first storage container located in the first section to a second storage container located in the second section.

In one aspect the first storage container is always located within the protected area and the second storage container is always located within the non-protected area.

In one aspect, the first container handler is designated to move the first storage container between the storage column and the first section of the transfer station on the first side of the barrier; and wherein the second container handler is designated to move the second storage container between the second section of the transfer station and the access station on the second side of the barrier.

In one aspect, the system comprises one or more of the following:
a cleaning station for cleaning of the second storage container;
a disinfection station for disinfection of the second storage container;
an inspection station for inspection of the second storage container;
   wherein the second container handler is moving the second storage container from the access station to the second section of the transfer station via the cleaning station, the disinfection station and/or the inspection station.

In one aspect, the automated storage and retrieval system comprises a quarantined location.

In one aspect, the system comprises a first temporary storage system, wherein the second container handler is designated to move the second storage container with its product item from the second section of the transfer station to the access station via the first temporary storage system.

In one aspect, the system comprises a second temporary storage system, wherein the second container handler is designated to move the second storage container from the access station to the second section of the transfer station via the first temporary storage system.

In one aspect, the first container handler is a container handling vehicle.

In one aspect, the second container handler is a conveyor belt, a roller etc. The second container handler may also be a container handling vehicle.

In one aspect, the framework structure comprises vertical members between which the storage columns are provided.

In one aspect, the automated storage and retrieval system comprises a rail system provided on top of the framework structure and container handing vehicles moving on the rail system, wherein the container handing vehicles are configured to move the first storage container from its storage column to the transfer station and/or from the transfer station to one of the storage columns.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective view of a prior art storage container in which product items are stored.

FIG. 6 illustrates schematically a top view of the first embodiment of the automated storage and retrieval system.

FIG. 7a illustrates schematically an enlarged view of the dashed box A in FIG. 6.

FIG. 7b illustrates schematically a side view of the positions of the first storage container.

FIGS. 8a and 8b are schematical side views illustrating how the product item is moved through the transfer station.

FIG. 9 illustrates schematically a top view of an alternative embodiment of the automated storage and retrieval system.

FIG. 10a and FIG. 10b are alternative schematical side views illustrating how the product item is moved through the transfer station.

FIG. 11a-f are alternative schematical side views illustrating how the product item is moved through the transfer station.

FIG. 12 illustrates an alternative way of moving the second storage container from the access station.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

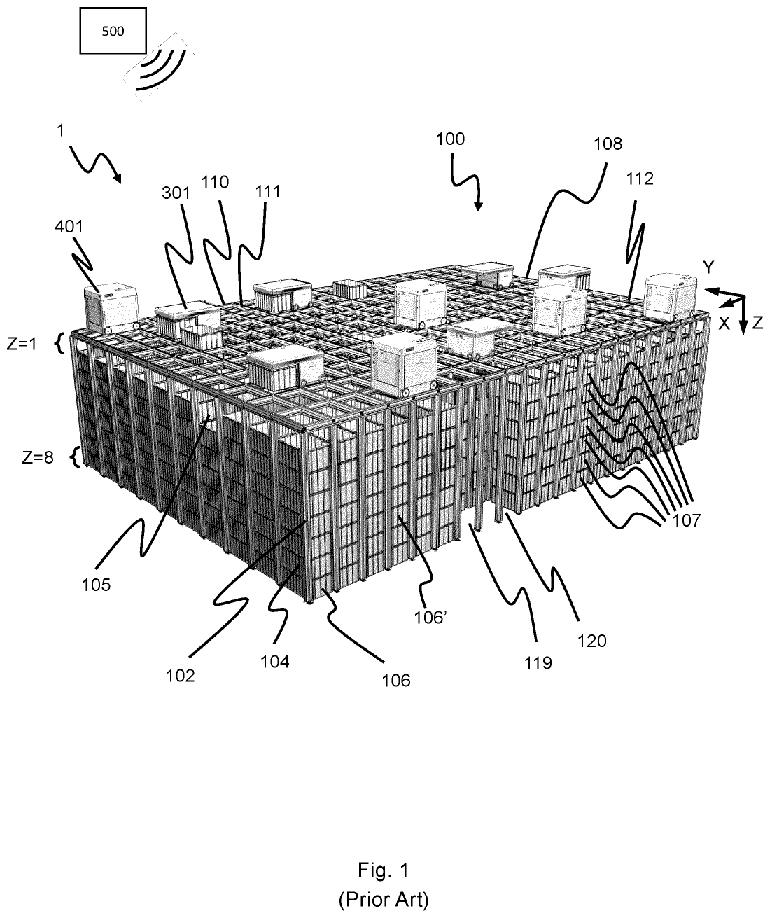

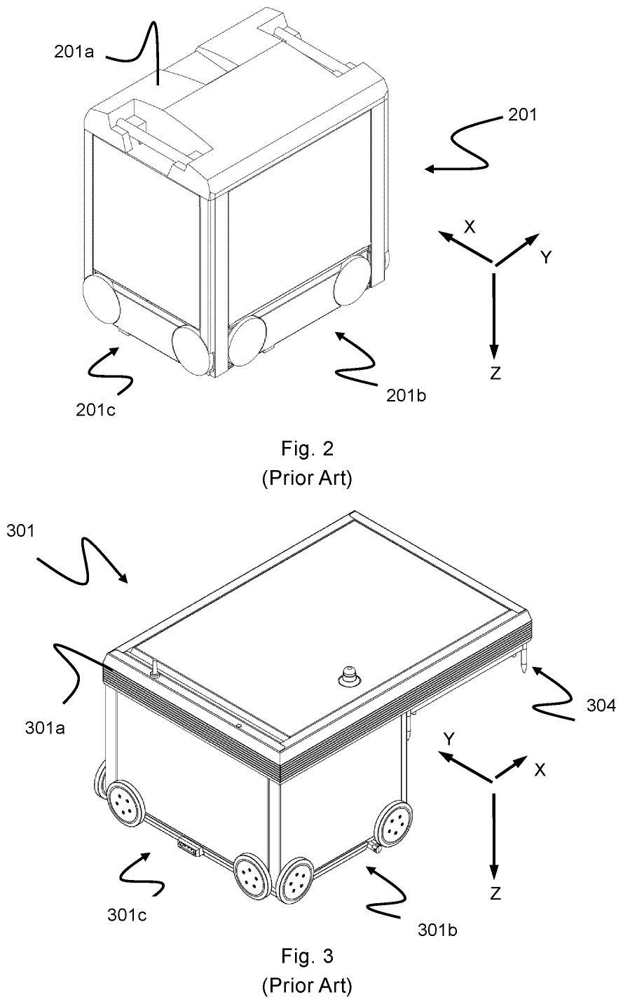

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

### Example 1

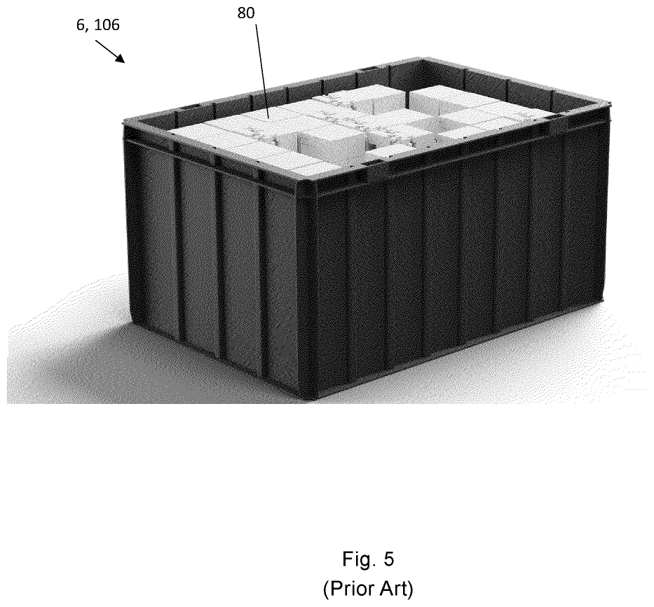

Initially, it is referred to FIG. 5, in which the storage container 106 used in the above automated storage and retrieval system 1 is shown. This storage container 106 is herein referred to as a first storage container 106. In the description below, it will also be referred to a second storage container 6. In the present embodiment, the second storage container 6 is of the same type as the first storage container 106. As also shown in FIG. 5, product items 80 are stored within the storage container 6, 106.

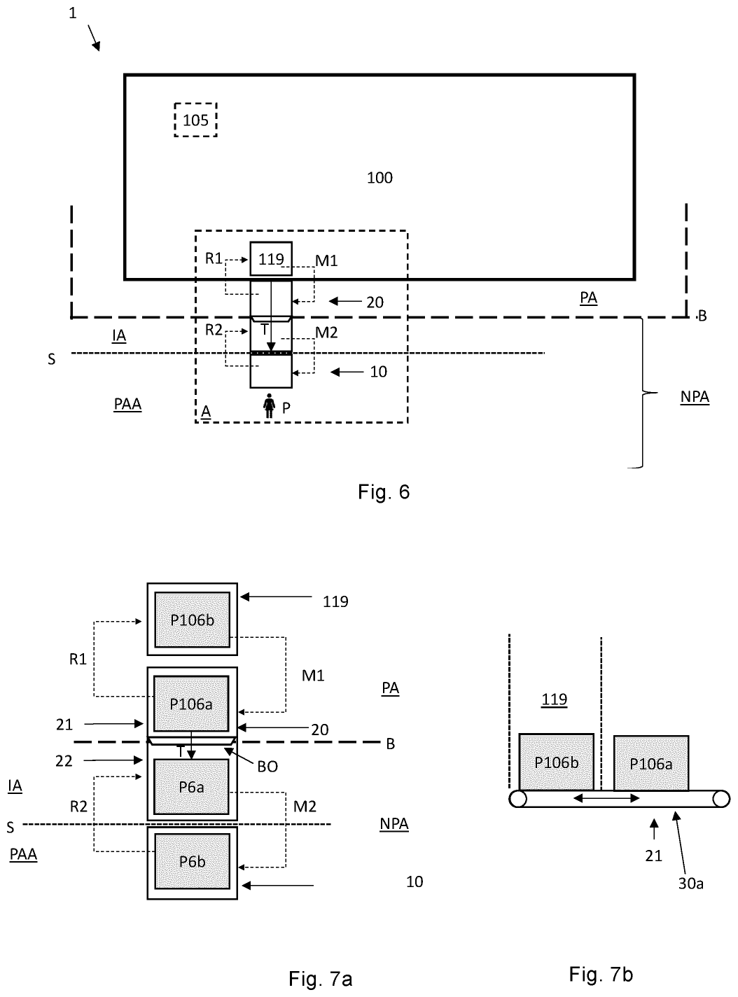

It is now referred to FIG. 6. Here, the framework structure 100 of the automated storage and retrieval system 1 is shown with one of many storage columns 105 indicated, and one port column 119.

The automated storage and retrieval system 1 comprises an access station 10 at which a person P may access the product item 80.

The access station 10 is preferably a public access station 10 at which a public person may retrieve product items 80 from the system 1. Such a public access station 10 may be referred to as a public pickup point. The access station 10 may be of a prior art type, for example an access station similar to the one disclosed in the above-mentioned WO 2017211596. This access station comprises a public user interface which provides access to the product item 80 by opening of a drawer after an identification process, a payment verification process etc. It should be noted that in the above-mentioned access station, the storage container is delivered vertically into the drawer. In the examples below, the storage container is delivered horizontally to the access station. It should be noted that the above-mentioned access station may be modified to receive storage containers horizontally as well.

The automated storage and retrieval system 1 comprises a transfer station 20 between the framework structure 100 and the access station 10. The transfer station 20 will be described further in detail below with reference to FIG. 7a and FIG. 7b.

First, it should be noted that FIG. 6 describes that the automated storage and retrieval system 1 comprises a barrier B separating the system 1 into a first area referred to as a protected area PA and a second area referred to as a non-protected area NPA. The access station 10 is located in the non-protected area NPA, while the framework structure 100 is located in the protected area PA. The barrier B is a physical barrier with a barrier opening BO.

The first storage container 106 is always located within the protected area PA. The second storage container 6 is always located within the non-protected area NPA.

The non-protected area NPA is further separated into a publicly accessible area PAA and an intermediate area IA by means of structure S. The intermediate area IA is hence forming a buffer area between the protected area PA and the publicly accessible area PAA.

The structure S may a building wall, a fence, a wall etc. Typically, while most of the access station 10 is located in the intermediate area IA, the public user interface is accessible for the person P from the publicly accessible area PAA.

It is now referred to FIG. 7a. Here, it is shown that the transfer station 20 is separated into a first section 21 and a second section 22. The first section 21 is provided within the protected area PA and is adapted to receive the first storage container 106 (as indicated by a position P106a in FIG. 7a). The second section 22 is provided within the non-protected area NPA and is adapted to receive the second storage container 6 (as indicated by a position P6a in FIG. 7a).

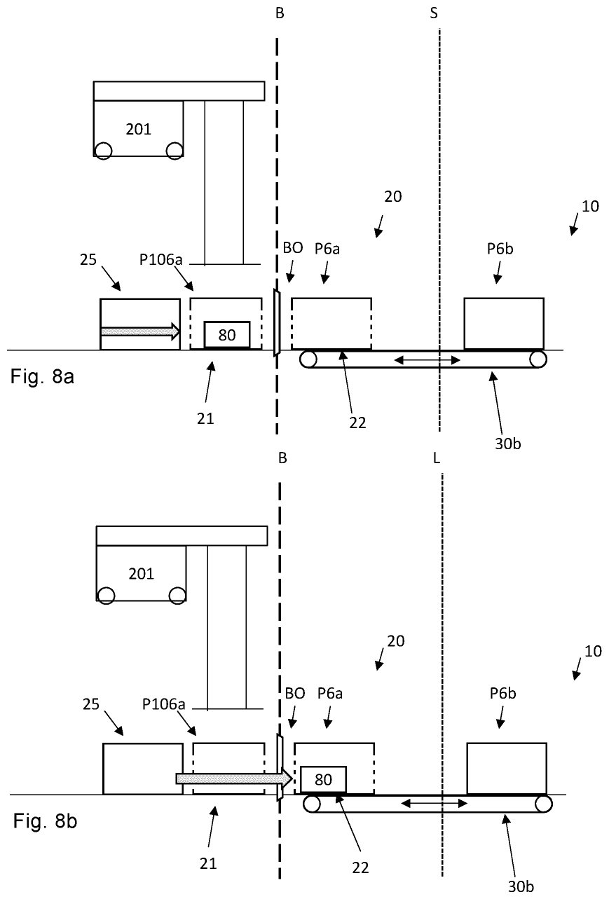

The transfer station 20 further comprises an actuator 25 (shown in FIG. 8a, 8b) for transferring the product item 80 from the first storage container 106 located within the first section 21 to the second storage container 6 located within the second section 22.

The automated storage and retrieval system 1 further container handlers for moving the storage containers 106, 6. In general, the one or plurality of container handlers on the first side of the barrier B are referred to as a first container handler, while the one or plurality of container handlers on the second side of the barrier B are referred to as a second container handler.

In the present description, conveyors are generally referred to as conveyors 30.

In the present embodiment, the first container handler comprises a container handler in the form of a container handling vehicle, for example one of the prior art container handling vehicles 201, 301, 401. In addition, the first container handler comprises a container handler (FIG. 7b) in the form of a conveyor 30a for moving the first storage container between the dedicated port column 119 and the first section 21 of the transfer station 20. The second container handler comprises a conveyor 30b (shown in FIG. 8a and FIG. 8b) for moving the second storage container 6 between second section 22 of the transfer station 20 and the access station 10.

The operation of the first embodiment of the system 1 will now be described. The operation is to move a product item 80 stored in a storage container 106 stored in a storage column 105 within the framework structure 100 to a person P at the access station 10.

In a first step M1, the first storage container 106 is moved from the storage column 105 to the first section 21 of the transfer station 20. This is done by means of the container handling vehicle 201, 301, 401 moving the first storage container 106 from the storage column 105 to the dedicated port column 119 to a position P106b. This is further done by means of the conveyor 30a moving the first storage container 106 between the dedicated port column 119 (position P106b) to the first section 21 of the transfer station 20 (position P106a).

A second storage container 6 is now present at the second section 22 of the transfer station 20.

In a second step T, the product item 80 is transferred from the first storage container 106 to the second storage container 6. The step of transferring T the product item 80 comprises transferring T the product item through the barrier opening BO in the barrier B.

In a third step R1, the first storage container 106 is returned from the first section 21 of the transfer station 20 to one of the storage columns 105 by means of the conveyor 30a and one of the container handling vehicles 201, 301, 401.

In a fourth step M2, the second storage container 6 is moved from the transfer station 20 to the access station 10. This is done by means of the conveyor 30b moving the second storage container 6 from the second section 22 of the transfer station 20 (position P6a) to the access station 10 (position P6b). At the position P6b, the person P is allowed to access the product item 80 from the second storage container 6.

In a fifth step R2, the second storage container 6 is returned from the access station 10 to the second section 22 of the transfer station 20 again by means of the conveyor 30b, ready to receive another product item 80.

It should be noted that the steps of moving M1 and returning RI the first storage container 106 comprises moving M1 and returning R1 the first storage container 106 on the first side (i.e. the protected area) of the barrier B. Hence, the first storage container 106 is never moved to the non-protected area NPA.

Moreover, the steps of moving M2 and returning R2 the second storage container 6 comprises moving M2 and returning R2 the second storage container 6 on the second side of the barrier B (i.e. the non-protected area) of the barrier B. Hence, the second storage container 6 is never moved to the protected area PA.

Consequently, the product item 80 is transferred in a one-way direction from the protected area PA, through the barrier opening BO of the barrier B to the intermediate area IA and further to the publicly accessible area PAA.

### Example 2

The second embodiment is similar to the first embodiment described above. Hence, only differences between the first and second embodiments will be described in detail herein.

First, it should be noted that the first storage container 106 and the second storage container 6 are not of the type shown in FIG. 5. Instead, the storage containers 106, 6 are of the type disclosed in the above-mentioned NO 344750, where the storage containers 106, 6 have side openings through which product items 80 may be pushed sideways into and out from the respective storage containers.

In FIG. 8a and FIG. 8b, the actuator 25 of the transfer station 20 is a linear actuator for performing the step T by pushing the product item 80 out through the side opening in the first storage container 106 and in through the side opening in the second storage container 6.

It should further be noted that in FIG. 8a and FIG. 8b, it is shown that the container handling vehicle 201 is lowering the first storage container 106 directly to the position P106a and is retrieving the first storage container 106 directly from the position P106a. Hence, the conveyor 30a in example 1 is not needed in the second embodiment.

### Example 3

The third embodiment is similar to the first embodiment described above. Hence, only differences between the first and third embodiments will be described in detail herein.

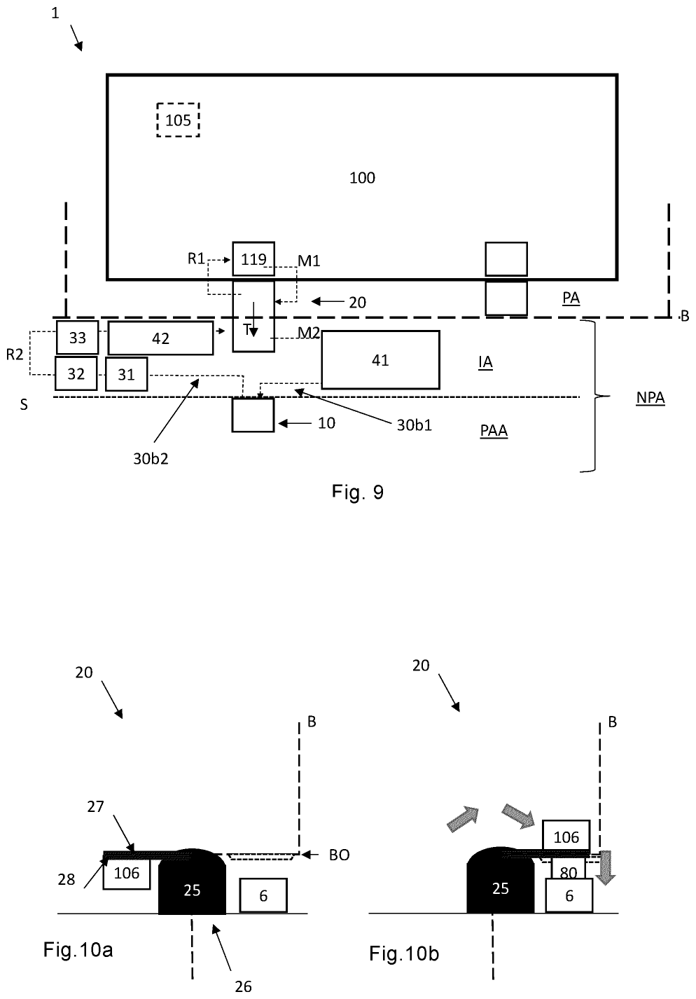

It is now referred to FIG. 9. The second container handler here comprises one or more conveyors indicated as a dashed arrow 30b1 in FIG. 9 and one or more conveyors indicated as a dashed arrow 30b2 in FIG. 9.

The system 1 here comprises a first temporary storage system 41 for temporarily storage of second storage containers 6 containing product items 80, in order to reduce waiting time for persons picking up their product items at the access station 10. The conveyor 30b1 is used to transport second storage containers 6 from the second section 22 of the transfer station and to the first temporary storage system 41 and from the first temporary storage system 41 to the access station 10.

The system 1 further comprises a cleaning station 31 for cleaning of the second storage container 6, a disinfection station 32 for disinfection of the second storage container 6, an inspection station 33 for inspection of the second storage container 6 and a second temporary storage system 42. The conveyor 30b2 is used to transport second storage containers 6 from the access station 10 to the second temporary storage system 42 via the stations 31, 32, 33 and to transport the second storage containers 6 from the second temporary storage system 42 to the second section 22 of the transfer station 20. The second storage containers 6 stored in the second temporary storage system 42 are empty.

It should be noted that a container handling vehicle 201, 301, 401 may be used to store second storage containers 6 in, and to retrieve second storage containers 6 from, the first temporary storage system 41 and the second temporary storage system 42. Hence, in this embodiment, also the second conveyor may comprise container handling vehicles.

It should further be noted that the second storage container may be moved to the inspection station 33 first, and then, based on the results from the inspection, the storage container 6 may be sent directly to the second temporary storage system 42 or to cleaning station 31 or to the disinfection station 32 before it is sent to the second temporary storage system 42. It is also possible to perform yet another inspection after the cleaning and/or disinfection.

### Example 4

The fourth embodiment is similar to the first, second and/or third embodiment described above. Hence, only differences between the first and fourth embodiments will be described in detail herein.

It is referred to FIG. 10a and FIG. 1b, in which an alternative embodiment of the actuator 25 of the transfer station 20 is shown.

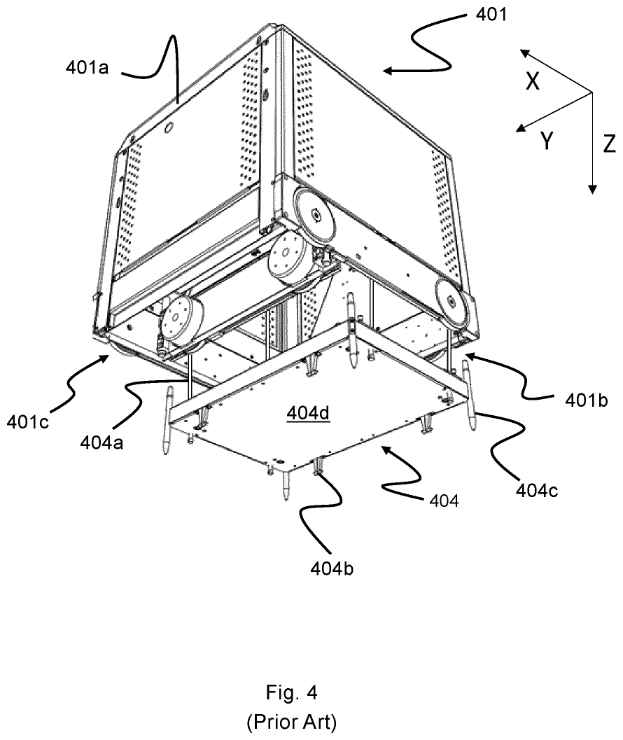

Here, the actuator 25 comprises a base 26 and an arm 27 pivotably connected to the base 26. The arm 27 comprises a connection interface 28 for connection to the first storage container 106. The connection interface 28 may be similar to the prior art gripper 404b of the container handling vehicle 401 (shown in FIG. 4).

In FIG. 10a, the connection interface 28 has been connected to the top of the first container 106. Then the arm is pivoted 180° to the position shown in FIG. 10b, causing the product item 80 to tip into the second storage container 6.

As shown in FIG. 10a and FIG. 10b, the barrier B is indicated as a dashed line, and wherein the border opening BO is indicated as a dashed line. Also here, the vertical parts of the barrier B may be a physical barrier. The arm 27 may be considered to be a part of this barrier B when the arm is in the position shown in FIG. 10b.

One advantage with this embodiment is that the open-top type of storage containers shown in FIG. 5 may be used.

### Example 5

The fifth embodiment is similar to the fourth embodiment.

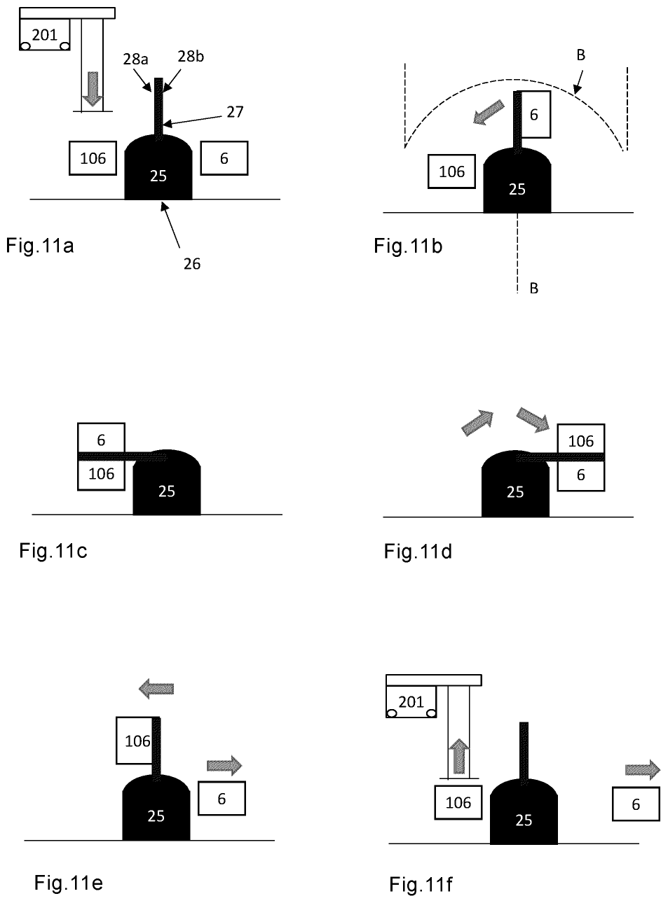

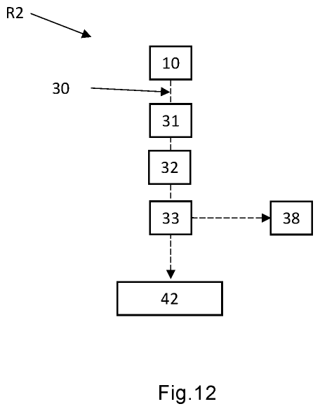

It is now referred to FIG. 11a. Here, the actuator 25 of the transfer station 20 comprises a base 26 and an arm 27 pivotably connected to the base 26. The arm 27 comprises two connection interfaces, a first connection interface 28a for connection to the first storage container 106 and a second connection interface 28b for connection to the second storage container 6.

In FIG. 11b, the actuator 25 is connected to the second storage container 6 (empty) and is moving towards the first storage container 106.

In FIG. 11c, the actuator 25 is connected to both the first storage container 106 and the second storage container 6.

In FIG. 11d, both the first storage container 106 and the second storage container 6 are moved, causing the product item 80 to tip into the second storage container 6.

In FIG. 1le, the first storage container 106 is moved back for retrieval by means of the container handling vehicle 201 (FIG. 11f) while the second storage container 6 (now containing the product item 80) is moved towards the access station 10.

The barrier B is indicated in FIG. 11b. The arm 27 is here considered to be a part of the barrier B. Hence, the first storage container 106 is also here on the first side of the barrier, while the second storage container 6 is always on the second side of the barrier. It should be noted that in this embodiment, it is theoretically possible for undesired matter to be transferred from the second storage container 6 to the first storage container 106 due to gravity when the arm is in the position shown in FIG. 11c (even though the second storage container 6 is not in directly contact with the first storage container 106). However, cleaning/disinfection/inspection may reduce this risk to an acceptable level.

### Example 6

The sixth embodiment is similar to the third embodiment described above.

Here, the automated storage and retrieval system 1 comprises a quarantined location 38 in which one or several second storage containers 6 may be stored. The inspection station 33 may be configured to determine if a second storage container 6 is to be sent to the second temporary storage system 42 or to the quarantined location 38.

### Alternative Embodiments

In the embodiment of FIG. 9, the container handler 30b1 is shown to move the second storage container 6 sequentially through the stations 31, 32, 33. It should be noted that the system 1 may comprise only one or two of these stations, or the system 1 may comprise an initial inspection station to determine if cleaning/disinfection is needed and a final inspection station to determine if the cleaning/disinfection was successful.

In the preceding description, various aspects of the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Prior art automated storage and retrieval system
6 Second storage container
10 Access station
20 transfer station
21 First section of transfer station
22 Second section of transfer station
25 Actuator
26 Base
27 Arm
28 Connection interface
28a First connection interface
28b Second connection interface
30 Conveyor
30a Conveyor
30b Conveyor
30b1 Conveyor
30b2 Conveyor
31 Cleaning station
32 Disinfection station
33 Inspection station
38 Quarantined location
41 First temporary storage system
42 Second temporary storage system
80 Product item
100 Framework structure
102 Upright members of framework structure
104 Storage grid
10 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
X First direction
Y Second direction
Z Third direction

1. A method for transporting a product item stored within a first storage container within an automated storage and retrieval system to an access station, wherein the method comprises:
moving the first storage container from a storage column to a transfer station;
transferring the product item from the first storage container to a second storage container at the transfer station;
returning the first storage container from the transfer station to the automated storage and retrieval system;
moving the second storage container from the transfer station to an access station at which a person may access the product item;
returning the second storage container from the access station to the transfer station.

2. The method according to claim 1, wherein moving and returning the first storage container comprises moving and returning the first storage container on a first side of a barrier; wherein moving and returning the second storage container comprises moving and returning the second storage container on a second side of the barrier; wherein transferring the product item comprises transferring the product item from the first storage container to the second storage container through the barrier at the transfer station.

3. The method according to claim 2, wherein transferring the product item from the first storage container to a second storage container at the transfer station comprises:
keeping the first storage container at a distance from the second storage container during the transfer.

4. The method according to claim 1, wherein moving the second storage container comprises:
temporarily storing the second storage container with the product item in a first temporary storage system.

5. The method according to claim 1, wherein returning the second storage container from the access station to the transfer station comprises:
temporarily storing the second storage container in a second temporary storage system .

6. The method according to claim 1, wherein returning the second storage container from the access station to the transfer station comprises:
bringing the second storage container to a cleaning station for cleaning of the second storage container.

7. The method according to claim 1, wherein returning the second storage container from the access station to the transfer station comprises:
bringing the second storage container to a disinfection station for disinfection of the second storage container.

8. The method according to claim 1, wherein returning the second storage container from the access station to the transfer station comprises:
bringing the second storage container to an inspection station for inspection of the second storage container.

9. An automated storage and retrieval system comprising a framework structure and a storage volume comprising storage columns, wherein a product item is stored within a first storage container stackable in stacks within the storage columns; wherein the automated storage and retrieval system comprises:
an access station at which a person may access the product item;
a transfer station;
wherein the transfer station comprises:
a first section for receiving the first storage container;
a second section for receiving a second storage container;
an actuator for transferring the product item from the first storage container located in the first section to a second storage container located at the second section;
wherein the automated storage and retrieval system comprises a first container handler for moving the first storage container between the storage column and the first section of the transfer station;
wherein the automated storage and retrieval system comprises a second container handler for moving the second storage container between the second section of the transfer station and the access station.

10. The automated storage and retrieval system according to claim 9, wherein the automated storage and retrieval system comprises a barrier separating the system between a protected area and a non-protected area, wherein the first section of the transfer station is provided within the protected area and wherein the second section of the transfer station is provided within the non-protected area.

11. The automated storage and retrieval system according to claim 10, wherein the barrier is a physical barrier with a barrier opening allowing transfer of the product item from the first storage container located in the first section to a second storage container located in the second section.

12. The automated storage and retrieval system according to claim 10, wherein the first storage container is always located within the protected area and the second storage container is always located within the non-protected area.

13. The automated storage and retrieval system according to claim 10, wherein the first container handler is designated to move the first storage container between the storage column and the first section of the transfer station on the first side of the barrier; and wherein the second container handler is designated to move the second storage container between the second section of the transfer station and the access station on the second side of the barrier.

14. The automated storage and retrieval system according to claim 9, wherein the system comprises one or more of the following:
a cleaning station for cleaning of the second storage container;
a disinfection station for disinfection of the second storage container;
an inspection station for inspection of the second storage container;
wherein the second container handler is moving the second storage container from the access station to the second section of the transfer station via the cleaning station, the disinfection station, and/or the inspection station.

15. The automated storage and retrieval system according to claim 9, wherein the system comprises a first temporary storage system, wherein the second container handler is designated to move the second storage container with the product item from the second section of the transfer station to the access station via the first temporary storage system.

16. The automated storage and retrieval system according to claim 9, wherein the system comprises a second temporary storage system, wherein the second container handler is designated to move the second storage container from the access station to the second section of the transfer station via the first temporary storage system.
